(19) United States
(12) Patent Application Publication
(10) Pub. No.: US 2026/0093071 A1
(43) Pub. Date: Apr. 2, 2026

(54) WAVELENGTH DIVISION MULTIPLEXER

(71) Applicant: Optimal Coatech (Guangzhou) Co., Ltd., Guangzhou (CN)

(72) Inventors: Yong Tu, Guangzhou (CN); Weiliang He, Guangzhou (CN)

(21) Appl. No.: 18/914,738

(22) Filed: Oct. 14, 2024

(30) Foreign Application Priority Data
Sep. 29, 2024 (CN) 2024113812862

(51) Int. Cl. G02B 6/293

(52) U.S. Cl. CPC G02B 6/29365; G02B 6/2938

(57) ABSTRACT

A wavelength division multiplexer includes a prism, a collimator, and a filter group. The collimator injects an optical input signal into an input surface of the prism. The filter group is coupled to the prism. The filter group comprises a plurality of filters successively coupled to each other. Each filter reflects a different wavelength of the optical input signal and permits other wavelengths of the optical input signal to pass through to a next filter of the filter group.

### CROSS-REFERENCE TO RELATED APPLICATIONS

The present application claims priority of Chinese patent application CN2024113812862 filed on September 29, 2024. The aforementioned application is hereby incorporated herein by reference in its entirety.

### TECHNICAL FIELD

Aspects of the present disclosure are related to multiplexers, and in particularly to wavelength division multiplexers.

### BACKGROUND

Conventional wavelength division multiplexers are large and do not provide a fine enough optical pitch.

### BRIEF SUMMARY OF THE DISCLOSURE

Shown in and/or described in connection with at least one of the figures, and set forth more completely in the claims are wavelength division multiplexers, which may provide a more laterally-compact arrangement than conventional wavelength division multiplexers.

These and other advantages, aspects and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts a first embodiment of a wavelength division multiplexer.

FIG. 2 depicts a second embodiment of a wavelength division multiplexer.

FIG. 3 depicts a third embodiment of a wavelength division multiplexer.

### DESCRIPTION

The following discussion provides various examples of wavelength division multiplexers that may provide a more laterally-compact arrangement than conventional wavelength division multiplexers. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

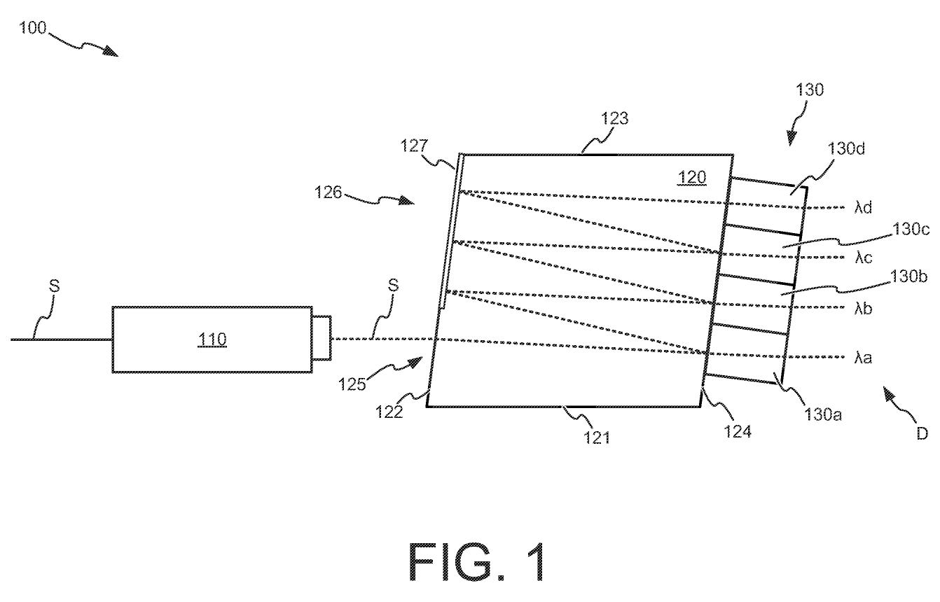

Referring now to FIG. 1, a wavelength division multiplexer 100 is shown. In particular, the wavelength division multiplexer 100 of FIG. 1 may include a collimator 110, a prism 120, and a filter group 130. The collimator 110 may receive an optical input signal S from an optical source (e.g., a multimode optical fiber) incident to the collimator 110. The collimator 110 may further inject the received optical input signal S into the prism 120.

The prism 120 may comprise a glass block or a block of other dielectric material defining a prism lower surface 121, a prism input surface 122, a prism upper surface 123, and a prism output surface 124. As depicted, the prism output surface 124 may be positioned laterally opposite and parallel to the prism input surface 122. The prism lower surface 121 and the prism upper surface 123 may be between the prism input surface 122 and the prism output surface 124. In some embodiments, the prism upper surface 123 may be positioned vertically opposite and parallel to the prism lower surface 121.

The prism input surface 122 may include an input portion 125 through which the collimator 110 may inject the optical input signal S into the prism 120. The prism input surface 122 may also include a reflective portion 126 coated with a reflective film 127. The reflective film 127 along the prism input surface 122 may reflect the optical input signal S and its associated wavelengths toward the prism output surface 124. In various embodiments, the input portion 125 is not coated with the reflective film 127.

The filter group 130 may include a first filter 130a, a second filter 130b, a third filter 130c, and a fourth filter 130d along the prism output surface 124. In particular, the first filter 130a may be positioned laterally opposite the input portion 125 of the prism input surface 122. As such, the optical input signal S may pass from the input portion 125 of the prism input surface 122, laterally through the prism 120, to the first filter 130a. Further, the second filter 130b may be positioned above and offset from the first filter 130a by a first offset distance, the third filter 130c may be positioned above and offset from the second filter 130b by a second offset distance, and the fourth filter 130d may be positioned above and offset from the third filter 130c by a third offset distance. In some embodiments, the filters 130a-130d may be offset from one another along the prism output surface 124 by a same offset distance. Moreover, a divided optical output signal D may exit the filters 130a-130d such that the divided wavelength signals have a signal pitch (i.e., distance between divided wavelength signals) equal to the offsets of the filters 130a-130d.

The first filter 130a and/or the prism output surface 124 of the prism 120 may provide a first passband that permits a first wavelength λa of the optical input signal S to pass through the prism output surface 124 and out the first filter 130a as a first divided wavelength signal λa of the divided optical output signal D. The first filter 130a and/or the prism output surface 124 of the prism 120 may reflect other wavelengths (e.g., wavelengths λb, λc, and λd) of the optical input signal S back toward the reflective portion 126 of the prism input surface 122. The reflective film 127 along the reflective portion 126 of the prism input surface 122 may reflect the optical input signal S including wavelengths λb, λc, and λd received from the first filter 130a toward the second filter 130b.

The second filter 130b and/or the prism output surface 124 of the prism 120 may provide a second passband that permits a second wavelength λb of the optical input signal S to pass through the prism output surface 124 and out the second filter 130b as a second divided wavelength signal λb of the divided optical output signal D. In particular, the second wavelength λb of the optical input signal S may exit the second filter 130b parallel to and offset from the first wavelength λa of the optical input signal S by the first offset distance between filters 130a, 130b. Moreover, the second filter 130b and/or the prism output surface 124 may reflect other wavelengths (e.g., wavelengths λc and λd) of the optical input signal S back toward the reflective portion 126 of the prism input surface 122. The reflective film 127 along the reflective portion 126 of the prism input surface 122 may reflect the optical input signal S including the wavelengths λc and λd received from the second filter 130b toward the third filter 130c.

The third filter 130c and/or the prism output surface 124 of the prism 120 may provide a third passband that permits a third wavelength λc of the optical input signal S to pass through the prism output surface 124 and out the third filter 130c as a third divided wavelength signal λc of the divided optical output signal D. In particular, the third wavelength λc of the optical input signal S may exit the third filter 130c parallel to and offset from the second wavelength of the optical input signal S by the second offset between the filters 130b, 130c. Moreover, the third filter 130c and/or the prism output surface 124 may reflect other wavelengths (e.g., wavelength λd) of the optical input signal S back toward the reflective portion 126 of the prism input surface 122. The reflective film 127 along the reflective portion 126 of the prism input surface 122 may reflect the optical input signal S including the wavelength λd received from the third filter 130c toward the fourth filter 130d.

The fourth filter 130d and/or the prism output surface 124 of the prism 120 may provide a fourth passband that permits a fourth wavelength λd of the optical input signal S to pass through the prism output surface 124 and out the fourth filter 130d as a fourth divided wavelength signal λd of the divided optical output signal D. In particular, the fourth wavelength λd of the optical input signal S may exit the fourth filter 130d parallel to and offset from the third wavelength λc of the optical input signal S by the third offset between the third filter 130c and the fourth filter 130d.

While FIG. 1 depicts the wavelength division multiplexer 100 with four filters 130a-130d which divide the optical input signal S and output a divided optical output signal D comprising four divided wavelength signals λa, λb, λc, and λd, the wavelength division multiplexer 100 may include a different quantity of filters 130a-130d which divide the optical input signal S into a respective quantity of wavelength signals.

Moreover, while the wavelength division multiplexer 100 of FIG. 1 may be effective in dividing the optical input signal S into a respective quantity of wavelength signals, the wavelength division multiplexer 100 positions the collimator 110 and the optical source (e.g., an incident optical fiber) laterally inline with the prism 120 and the filter group 130. Such laterally inline positioning may consume more lateral space than desired for certain uses.

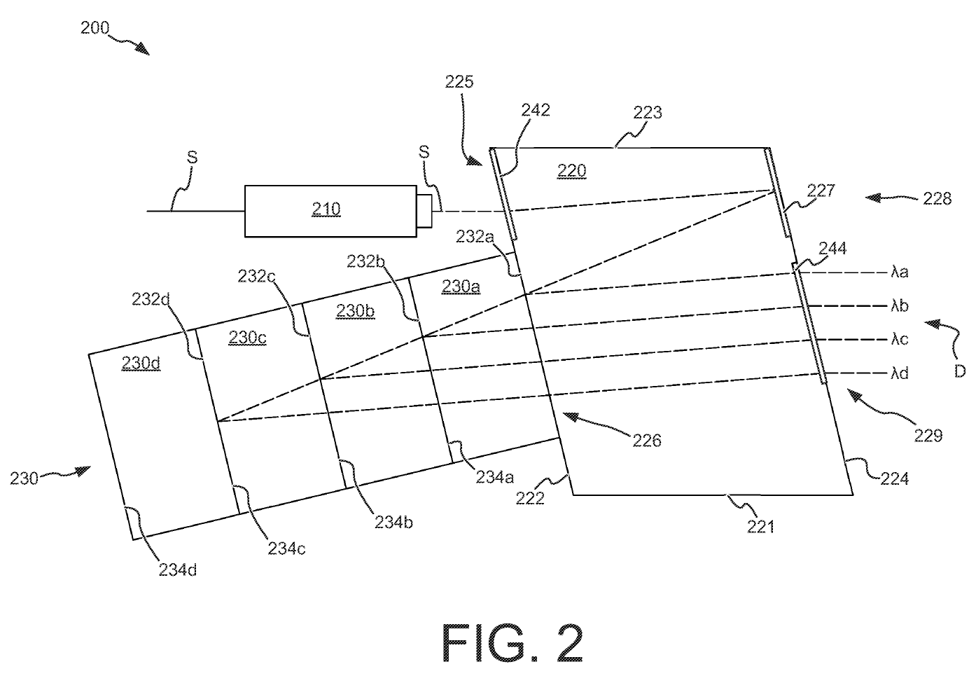

FIG. 2 depicts another wavelength division multiplexer 200, which in some embodiments consumes less lateral space than the wavelength division multiplexer 100 of FIG. 1. Similar to the wavelength division multiplexer 100 of FIG. 1, the wavelength division multiplexer 200 of FIG. 2 comprises a collimator 210, a prism 220, and a filter group 230. However, unlike the wavelength division multiplexer 100 of FIG. 1, the collimator 210 and the filter group 230 are longitudinally arranged. Moreover, the collimator 210 and the filter group 230 are positioned on the same side of the prism 220. As such, the collimator 210 may laterally overlap the filter group 230. Therefore, the wavelength division multiplexer 200 may be implemented in a more laterally-compact manner than the wavelength division multiplexer 100.

To this end, the collimator 210 may receive an optical input signal S from an optical source (e.g., a multimode optical fiber) incident to the collimator 210. The collimator 210 may further inject the received optical input signal S into the prism 220.

The prism 220 may comprise a glass block or a block of other dielectric material defining a prism lower surface 221, a prism input surface 222, a prism upper surface 223, and a prism output surface 224. As depicted, the prism output surface 224 may be positioned laterally opposite and parallel to the prism input surface 222. The prism lower surface 221 and the prism upper surface 223 may be between the prism input surface 222 and the prism output surface 224. In some embodiments, the prism upper surface 223 may be positioned vertically opposite and parallel to the prism lower surface 221.

The prism input surface 222 may include an input portion 225 and a filter interface portion 226. The collimator 210 may inject the optical input signal S into the prism 220 via the input portion 225. An anti-reflective film 242 may be coated or otherwise positioned along an input portion 225 of the prism input surface 222. A filter interface portion 226 of the prism input surface 222 may be uncoated and/or polished to provide an interface to the filter group 230 extending from the prism input surface 222. A reflective film 227 may be coated or otherwise positioned along a reflective portion 228 of the prism output surface 224. An anti-reflective film 244 may be coated or otherwise positioned along an output portion 229 of the prism output surface 224. In some embodiments, the prism lower surface 221 and the prism upper surface 223 may be frosted.

In various embodiments, the prism 220 may be implemented as a glass parallelepiped. In such embodiments, the prism input surface 222 and the prism upper surface 223 may form an acute angle ranging between 72° and 82°. Moreover, the anti-reflective films 242, 244 may be formed using an electron beam evaporation coating technique to obtain the anti-reflective coatings with a reflectance R < 0.25% for wavelengths between about 1240 nm and 1360 nm and an angle of incidence (AOI) between about 8° and 18°. Similarly, the reflective films may be formed using an electron beam evaporation coating technique to obtain the reflective coatings with a reflectance R > 99.7% for wavelengths between about 1240 nm and 1360 nm and an angle of incidence (AOI) between about 5.31° and 6.14°

The filter group 230 may comprise a first filter 230a, a second filter 230b, a third filter 230c, and a fourth filter 230d. The filter group 230 may divide and spatially separate the optical input signal S into a plurality of wavelength signals (e.g., wavelength signals λa, λb, λc, and λd). Moreover, the filter group 230 may reflect or otherwise direct the spatially-separated wavelength signals out the output portion 229 of the prism output surface 224. To this end, the filter group 230 may comprise a first filter 230a, a second filter 230b, a third filter 230c, and a fourth filter 230d. The four filters 230a-230d of the filter group 230 may provide four reflective band-pass filters stacked and coupled to one another with a bonding material such as an ultraviolet (UV) glue.

The first filter 230a may comprise a first filter input surface 232a coupled to the filter interface portion 226 of the prism input surface 222 and a first filter output surface 234a laterally opposite the first filter input surface 232a. Moreover, the first filter input surface 232a may be coated with a reflective coating that reflects light centered about a first wavelength λa (e.g., 1271 nm) of the optical input signal S and out the prism output surface 224 as a first wavelength signal λa of the divided optical output signal D. Moreover, the reflective coating along the first filter input surface 232a may permit other wavelengths (e.g., wavelength λb, λc, and λd) of the optical input signal S to pass through the first filter 230a and to the first filter output surface 234a. In various embodiments, the first filter output surface 234a is uncoated and/or polished to aid passage of the other wavelengths of the optical input signal S to the second filter 230b.

The second filter 230b may comprise a second filter input surface 232b coupled to the first filter output surface 234a and a second filter output surface 234b laterally opposite the second filter input surface 232b. Moreover, the second filter input surface 232b may be coated with a reflective coating that reflects light centered about a second wavelength λb (e.g., 1291 nm) of the optical input signal S and out the output portion 229 of the prism 220 as a second wavelength signal λb of the divided optical output signal D. Moreover, the reflective coating along the second filter input surface 232b may permit other wavelengths (e.g., wavelength λc and λd) of optical input signal S to pass through the second filter 230b and to the second filter output surface 234b. In various embodiments, the second filter output surface 234b is uncoated and/or polished to aid passage of the other wavelengths of the optical input signal S to the third filter 230c.

The third filter 230c may comprise a third filter input surface 232c coupled to the second filter output surface 234b and a third filter output surface 234c laterally opposite the third filter input surface 232c. Moreover, the third filter input surface 232c may be coated with a reflective coating that reflects light centered about a third wavelength λc (e.g., 1311 nm) of the optical input signal S and out the output portion 229 of the prism 220 as a third wavelength signal λc of the divided optical output signal D. Moreover, the reflective coating along the third filter input surface 232c may permit other wavelengths (e.g., wavelength λd) of the optical input signal S to pass through the third filter 230c and to the third filter output surface 234c. In various embodiments, the third filter output surface 234c may be uncoated and/or polished to aid passage of the other wavelengths (e.g., wavelength λd) of the optical input signal S to the fourth filter 230d.

The fourth filter 230d may comprise a fourth filter input surface 232d coupled to the third filter output surface 234c and a fourth filter output surface 234d laterally opposite the fourth filter input surface 232d. Moreover, the fourth filter input surface 232d may be coated with a reflective coating that reflects light centered about the fourth wavelength λd (e.g., 1331 nm) of the optical input signal S and out the output portion 229 of the prism 220 as a fourth wavelength signal λd of the divided optical output signal D. Moreover, the reflective coating along the fourth filter input surface 232d may permit other wavelengths of the optical input signal S to pass through the fourth filter 230d and to the fourth filter output surface 234d. In various embodiments, the fourth filter output surface 234d may be uncoated and/or polished to aid passage of the other wavelengths of the optical input signal S through the fourth filter output surface 234d.

In some embodiments, the first filter 230a, the second filter 230b, the third filter 230c, and the fourth filter 230d may be implemented using WMS-15 glass-ceramic substrates available from Ohara Corp. Such substrates may be successively coated with a high refractive index film and a low refractive index film to provide a band-pass reflective film structure. In some embodiments, a magnetron sputtering technique may be used to coat the substrate of the filters 230a-230d with the high and low refractive index film materials. Moreover, in some embodiments, the high refractive index material may be implemented with tantalum pentoxide (Ta₂O₅), which has a refractive index of roughly 2.13 and the low refractive index film material may be implemented with silicon dioxide (SiO₂), which has a refractive index of roughly 1.46.

Due to the arrangement of the prism 220 and the filter group 230, the wavelength division multiplexer 200 may provide a shorter optical path than the wavelength division multiplexer 100 between input and output of the wavelength division multiplexer 100. As a result of such reduced optical path, the wavelength division multiplexer 200 may provide a smaller pitch (i.e., smaller offset between) for the divided wavelengths λa λb λc λd output from the prism 220 compared to other reflective-type wavelength division multiplexers such as the wavelength division multiplexer 100 of FIG. 1. Moreover, such arrangement may permit the wavelength division multiplexer 200 to be implemented in a more laterally-compact manner than other reflective-type wavelength division multiplexers such as the wavelength division multiplexer 100 of FIG. 1.

FIG. 2 depicts the wavelength division multiplexer 200 with four filters 230a-230d which divide the optical input signal S into four divided wavelength signals λa, λb, λc, and λd. However, the wavelength division multiplexer 200 in some embodiments may include a different quantity of filters 230a-230d which divide the optical input signal S into a respective quantity of wavelength signals.

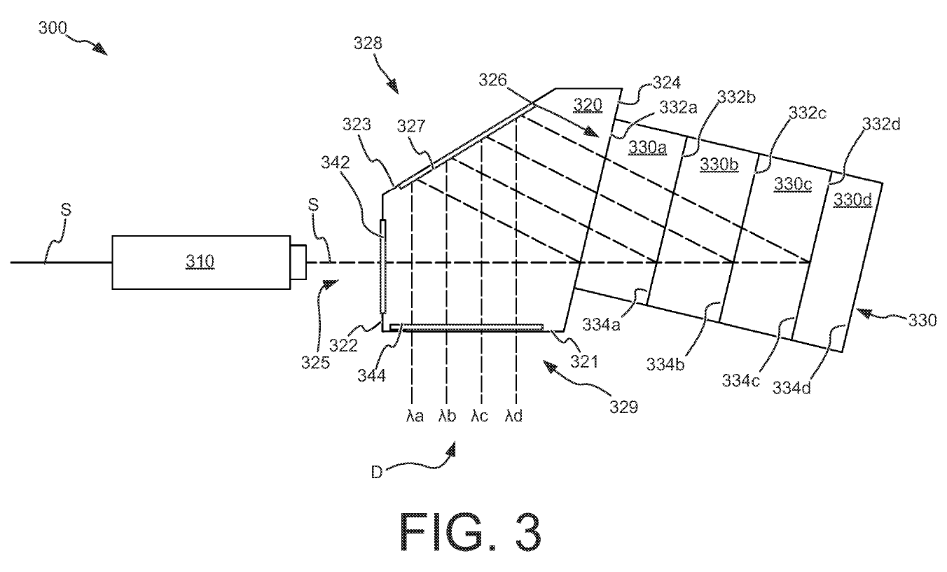

FIG. 3 depicts a wavelength division multiplexer 300, which in some embodiments consumes less lateral space than the wavelength division multiplexer 100 of FIG. 1. Similar to the wavelength division multiplexer 100 of FIG. 1, the wavelength division multiplexer 300 of FIG. 3 comprises a collimator 310, a prism 320, and a filter group 330. However, unlike the wavelength division multiplexer 100 of FIG. 1, the divided light is output from the prism 320 from a prism lower output surface 321 that adjoins a prism lateral input surface 322. In the depicted embodiment, the prism lower output surface 321 is coupled to the prism lateral input surface 322 at an angle of 90°, thus resulting in the divided optical output signal D exiting the prism 320 at an angle of 90° with regard to the optical input signal S injected into the prism 320. However, other embodiments of the wavelength division multiplexer 300 may adjoin the prism lower output surface 321 to the prism lateral input surface 322 at other angles (e.g., any angle between 60° and 120°). Such orientation of the prism lower output surface 321 to the prism lateral input surface 322 may permit implementing the wavelength division multiplexer 300 in a more laterally-compact manner than the wavelength division multiplexer 100 with regard to the spatial separation between input and output of the prism 320.

To this end, the collimator 310 may receive an optical input signal S from an optical source (e.g., a multimode optical fiber) incident to the collimator 310. The collimator 310 may further inject the received optical input signal S into the prism 320.

The prism 320 may comprise a glass block or a block of other dielectric material defining a prism lower output surface 321, a prism lateral input surface 322, a prism upper surface 323, and a prism lateral surface 324. As depicted, the prism lateral surface 324 may be positioned laterally opposite the prism lateral input surface 322 and angled to reflect portions of the optical input signal S toward the prism upper surface 323. The prism lower output surface 321 and the prism upper surface 323 may be between the prism lateral input surface 322 and the prism lateral surface 324. In some embodiments, the prism upper surface 323 may be positioned vertically over the prism lower output surface 321 and angled with respect to the prism lateral surface 324 in order to reflect signals from the prism lateral surface 324 out the prism lower output surface 321.

The prism lateral input surface 322 may include an input portion 325. The collimator 310 may inject the optical input signal S into the prism 320 via the input portion 325. An anti-reflective film 342 may be coated or otherwise positioned along the input portion 325 of the prism lateral input surface 322. The prism lateral surface 324 may include a filter interface portion 326. The filter interface portion 326 may be uncoated and/or polished to provide an interface to the filter group 330 extending from the prism lateral surface 324. A reflective film 327 may be coated or otherwise positioned along a reflective portion 328 of the prism upper surface 323. An anti-reflective film 344 may be coated or otherwise positioned along an output portion 329 of the prism lower output surface 321.

In various embodiments, the prism 320 may be implemented using glass or other dielectric materials. Moreover, the anti-reflective films 342, 344 may be formed using an electron beam evaporation coating technique to obtain anti-reflective coatings with a reflectance R < 0.25% for wavelengths between about 1240 nm and 1360 nm. Similarly, the reflective films may be formed using an electron beam evaporation coating technique to obtain the reflective coatings with a reflectance R > 99.7% for wavelengths between about 1240 nm and 1360 nm.

The filter group 330 may divide and spatially separate the optical input signal S into a plurality of wavelength signals (e.g., wavelength signals λa, λb, λc, and λd). Moreover, the filter group 330 may reflect or otherwise direct the spatially-separated wavelength signals toward the reflective portion 328 of the prism upper surface 323. To this end, the filter group 330 may comprise a first filter 330a, a second filter 330b, a third filter 330c, and a fourth filter 330d. The four filters 330a-330d of the filter group 330 may provide four reflective band-pass filters stacked and coupled to one another with a bonding material such as an ultraviolet (UV) glue.

The first filter 330a may comprise a first filter input surface 332a coupled to the filter interface portion 326 of the prism lateral surface 324 and a first filter output surface 334a laterally opposite the first filter input surface 332a. Moreover, the first filter input surface 332a may be coated with a reflective coating that reflects light centered about a first wavelength λa (e.g., 1271 nm) of the optical input signal S toward the reflective film 327 along the prism upper surface 323. The prism upper surface 323 may in turn reflect the first wavelength λa out the output portion 329 of the prism lower output surface 321 as a first wavelength signal λa of the divided optical output signal D. Moreover, the reflective coating along the first filter input surface 332a may permit other wavelengths (e.g., wavelength λb, λc, and λd) of the optical input signal S to pass through the first filter 330a and to the first filter output surface 334a. In various embodiments, the first filter output surface 334a is uncoated and/or polished to aid passage of the other wavelengths of the optical input signal S to the second filter 330b.

The second filter 330b may comprise a second filter input surface 332b coupled to the first filter output surface 334a and a second filter output surface 334b laterally opposite the second filter input surface 332b. Moreover, the second filter input surface 332b may be coated with a reflective coating that reflects light centered about a second wavelength λb (e.g., 1291 nm) of the optical input signal S toward the reflective film 327 along the prism upper surface 323. The prism upper surface 323 may in turn reflect the second wavelength λb out the output portion 329 of the prism lower output surface 321 as a second wavelength signal λb of the divided optical output signal D. Moreover, the reflective coating along the second filter input surface 332b may permit other wavelengths (e.g., wavelength λc and λd) of optical input signal S to pass through the second filter 330b and to the second filter output surface 334b. In various embodiments, the second filter output surface 334b is uncoated and/or polished to aid passage of the other wavelengths of the optical input signal S to the third filter 330c.

The third filter 330c may comprise a third filter input surface 332c coupled to the second filter output surface 334b and a third filter output surface 334c laterally opposite the third filter input surface 332c. Moreover, the third filter input surface 332c may be coated with a reflective coating that reflects light centered about a third wavelength λc (e.g., 1311 nm) of the optical input signal S toward the reflective film 327 along the prism upper surface 323. The prism upper surface 323 may in turn reflect the third wavelength λc out the output portion 329 of the prism lower output surface 321 as a third wavelength signal λc of the divided optical output signal D. Moreover, the reflective coating along the third filter input surface 332c may permit other wavelengths (e.g., wavelength λd) of the optical input signal S to pass through the third filter 330c and to the third filter output surface 334c. In various embodiments, the third filter output surface 334c may be uncoated and/or polished to aid passage of the other wavelengths (e.g., wavelength λd) of the optical input signal S to the fourth filter 330d.

The fourth filter 330d may comprise a fourth filter input surface 332d coupled to the third filter output surface 334c and a fourth filter output surface 334d laterally opposite the third filter input surface 332d. Moreover, the fourth filter input surface 332d may be coated with a reflective coating that reflects light centered about a fourth wavelength λd (e.g., 1331 nm) of the optical input signal S toward the reflective film 327 along the prism upper surface 323. The prism upper surface 323 may in turn reflect the fourth wavelength λd out the output portion 329 of the prism lower output surface 321 as a fourth wavelength signal λd of the divided optical output signal D. Moreover, the reflective coating along the fourth filter input surface 332d may permit other wavelengths of the optical input signal S to pass through the fourth filter 330d and to the fourth filter output surface 334d. In various embodiments, the fourth filter output surface 334d may be uncoated and/or polished to aid passage of the other wavelengths of the optical input signal S through the fourth filter output surface 334d.

In some embodiments, the first filter 330a, the second filter 330b, the third filter 330c, and the fourth filter 330d may be implemented using WMS-15 glass-ceramic substrates available from Ohara Corp. Such substrates may be successively coated with a high refractive index film and a low refractive index film to provide a band-pass reflective film structure. In some embodiments, a magnetron sputtering technique may be used to coat the substrate of the filters 330a-330d with the high and low refractive index film materials. Moreover, in some embodiments, the high refractive index material may be implemented with tantalum pentoxide (Ta₂O₅), which has a refractive index of roughly 2.13 and the low refractive index film material may be implemented with silicon dioxide (SiO₂), which has a refractive index of roughly 1.46.

Due to the arrangement of the prism 320 and the filter group 330, the wavelength division multiplexer 300 may provide a shorter optical path than the wavelength division multiplexer 100 between input and output of the wavelength division multiplexer 100. As a result of such reduced optical path, the wavelength division multiplexer 300 may provide a smaller pitch (i.e., smaller offset between) for the divided wavelengths λa λb λc λd output from the prism 320 compared to other reflective-type wavelength division multiplexers such as the wavelength division multiplexer 100 of FIG. 1. Moreover, such arrangement may permit the wavelength division multiplexer 300 to be implemented in a more laterally-compact manner than other reflective-type wavelength division multiplexers such as the wavelength division multiplexer 100 of FIG. 1.

FIG. 3 depicts the wavelength division multiplexer 300 with four filters 330a-330d which divide the optical input signal S into four divided wavelength signals λa, λb, λc, and λd. However, the wavelength division multiplexer 300 in some embodiments may include a different quantity of filters 330a-330d which divide the optical input signal S into a respective quantity of wavelength signals.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A wavelength division multiplexer, comprising:
a prism comprising a prism input surface and a prism output surface, wherein the prism input surface comprises an input portion configured to receive an optical input signal, and wherein the prism output surface comprises an output portion configured to output a divided optical output signal comprising a plurality of wavelength optical signals spatially separated by a pitch; and
a filter group coupled to a filter interface portion of the prism, wherein the filter group comprises a plurality of filters successively coupled to each other, wherein each filter reflects a different wavelength optical signal of the divided optical output signal and permits other wavelengths to pass through to a next filter of the plurality of filters.

2. The wavelength division multiplexer of claim 1, wherein:
the prism output surface is laterally opposite the prism input surface;
the prism input surface comprises the filter interface portion of the prism;
the prism output surface comprises the output portion and a reflective portion;
the reflective portion reflects the optical input signal toward the filter group; and
the filter group divides the optical input signal into a plurality of wavelength signals and reflects the plurality of wavelength signals out the output portion of the prism output surface.

3. The wavelength division multiplexer of claim 2, wherein the prism output surface is parallel to the prism input surface.

4. The wavelength division multiplexer of claim 2, wherein the reflective portion of the prism output surface comprises a reflective film.

5. The wavelength division multiplexer of claim 2, wherein the output portion of the prism output surface comprises an anti-reflective film.

6. The wavelength division multiplexer of claim 2, wherein the input portion of the prism input surface comprises an anti-reflective film.

7. The wavelength division multiplexer of claim 1, wherein:
a first filter of the filter group comprises a first filter input surface and a first filter output surface opposite the first filter input surface;
the first filter input surface is coupled to the filter interface portion and comprises a first reflective coating that reflects light centered about a first wavelength of the optical input signal and permits other wavelengths of the optical input signal to pass through the first filter output surface;
a second filter of the filter group comprises a second filter input surface and a second filter output surface opposite the second filter input surface; and
the second filter input surface is coupled to the first filter output surface and comprises a second reflective coating that reflects light centered about a second wavelength of the optical input signal and permits other wavelengths of the optical input signal to pass to the second filter output surface.

8. The wavelength division multiplexer of claim 1, wherein:
the prism output surface adjoins the prism input surface;
the prism comprises a prism lateral surface opposite the prism input surface;
the prism lateral surface comprises the filter interface portion of the prism;
the prism comprises an upper reflective portion opposite the prism output surface;
the filter group divides the optical input signal into a plurality of wavelength signals and reflects the plurality of wavelength signals toward the upper reflective portion; and
the upper reflective portion of the prism reflects the plurality of wavelength signals out the prism output surface.

9. The wavelength division multiplexer of claim 8, wherein the prism output surface and the prism input surface are adjoined at a 90° angle.

10. The wavelength division multiplexer of claim 8, wherein the prism output surface and the prism input surface are adjoined at an angle between 60° and 120°.

11. The wavelength division multiplexer of claim 8, wherein the upper reflective portion comprises a reflective film.

12. The wavelength division multiplexer of claim 8, wherein the output portion of the prism output surface comprises an anti-reflective film.

13. The wavelength division multiplexer of claim 8, wherein the input portion of the prism input surface comprises an anti-reflective film.

14. The wavelength division multiplexer of claim 1, comprising a collimator configured to inject the optical input signal into the prism via the prism input surface.

15. A wavelength division multiplexer, comprising:
a prism;
a collimator configured to inject an optical input signal into an input surface of the prism; and
a filter group coupled to the prism, wherein the filter group comprise a plurality of filters successively coupled to each other, wherein each filter reflects a different wavelength of the optical input signal and permits other wavelengths of the optical input signal to pass through to a next filter of the filter group.

16. The wavelength division multiplexer of claim 15, wherein:
an output surface of the prism is laterally opposite the input surface of the prism;
the filter group is coupled to the input surface of the prism;
a reflective portion of the prism reflects the optical input signal toward the filter group; and
the filter group divides the optical input signal into a plurality of wavelength signals and reflects the plurality of wavelength signals out the output surface of the prism.

17. The wavelength division multiplexer of claim 16, wherein the output surface of the prism is parallel to the input surface of the prism.

18. The wavelength division multiplexer of claim 16, wherein:
the output surface of the prism comprises an output portion coated with an anti-reflective film through which the plurality of wavelength signals exit the prism; and
the input surface of the prism comprises an input portion coated with an anti-reflective film through which the optical input signal is injected into the prism.

19. The wavelength division multiplexer of claim 15, wherein:
a first filter of the filter group comprises a first filter input surface and a first filter output surface opposite the first filter input surface;
the first filter input surface is coupled to the prism and comprises a first reflective coating that reflects light centered about a first wavelength of the optical input signal and permits other wavelengths of the optical input signal to pass through the first filter output surface;
a second filter of the filter group comprises a second filter input surface and a second filter output surface opposite the second filter input surface; and
the second filter input surface is coupled to the first filter output surface and comprises a second reflective coating that reflects light centered about a second wavelength of the optical input signal and permits other wavelengths of the optical input signal to pass to the second filter output surface.

20. The wavelength division multiplexer of claim 15, wherein:
an output surface of the prism adjoins the input surface of the prism;
a lateral side of the prism is opposite the input surface;
the filter group is coupled to the lateral side of the prism, divides the optical input signal into a plurality of wavelength signals, and reflects the plurality of wavelength signals toward a reflective surface of the prism; and
the reflective surface of the prism reflects the plurality of wavelength signals out the output surface of the prism.
